(19) United States
(12) Patent Application Publication
(10) Pub. No.: US 2020/0175281 A1
(43) Pub. Date: Jun. 4, 2020

(54) RELATION ATTENTION MODULE FOR TEMPORAL ACTION LOCALIZATION

(71) Applicant: International Business Machines Corporation, Armonk, NY (US)

(72) Inventors: Chuang Gan, YORKTOWN HEIGHTS, NY (US); Sijia Liu, YORKTOWN HEIGHTS, NY (US); Dakuo Wang, YORKTOWN HEIGHTS, NY (US); Yang Zhang, YORKTOWN HEIGHTS, NY (US)

(21) Appl. No.: 16/206,683

(22) Filed: Nov. 30, 2018

(51) Int. Cl. G06K 9/00; G06K 9/32; G06K 9/62; G06F 17/16; G06F 17/11

(52) U.S. Cl. CPC G06K 9/00765; G06K 9/00744; G06K 9/00718; G06K 2009/00738; G06K 9/6267; G06F 17/16; G06F 17/11; G06K 9/3233

(57) ABSTRACT

A method (and structure and computer product) of temporal action localization in video data includes receiving a stream of video data and determining all proposals in the video data stream, the proposals being candidate regions for temporal action in the video data stream. Values for a pair-wise relation function are calculated for relating the proposals, wherein the pair-wise relation function calculates a scalar value representing a pair-wise relation weight for pairs of the proposals.

### BACKGROUND

The present invention relates generally to temporal action detection in video. More specifically, a relation attention module uses a pair-wise relation to captures relations among video action proposals.

Temporal action localization aims to accurately localize and recognize all possible action instances from an untrimmed video. Most existing methods tackle this task by first generating a set of proposals of action instances and then recognizing each one independently. However, due to the complex structures and large content variations in action instances, recognizing proposals one by one can be difficult.

The task of temporal action localization has various potential applications in, for example, video classification and video surveillance. In this task, the background instances are removed beforehand to permit focus on classifying the trimmed video clips. However, in practice, it is very time-consuming and also very expensive to trim each video manually. In this sense, it would be highly desirable to localize the position of all possible action instances automatically and then recognize them.

Inspired by the success of the region-based paradigm established in R-CNN (Regional Convolutional Neural Network), most temporal action localization algorithms involve two stages: 1) generate proposals which are likely to contain actions; and 2) perform classification and boundary regression on each proposal individually. It is generally considered that contextual information helps object detection.

Based on this idea, some researchers have started to exploit contextual information to boost the performance of action localization. They have, for example, extended the receptive fields of each proposal and take the frames around the proposal into consideration, as exemplarily shown in FIG. 1. Thus, for a proposal 100, 102, features are extracted from the frames within and around that frame and then concatenated to form augmented features. In the context of the present invention, contextual information means information outside the image frame of a proposal, and a proposal refers to a region of pixels determined as suspected to be moving relative to the stationary background pixels.

Such operation enhances the proposal features by integrating more contextual features, but this kind of methods still suffer from two main issues:

1) The range of sampling contextual information is restricted to a local area and thus the global contextual information is neglected; and

2) The proposals are still recognized separately. This second issue always leads to performance drop since recognizing proposals one by one can be difficult, due to the complex structures and large content variations in action instances.

### SUMMARY

According to an exemplary embodiment, the present invention describes a method of temporal action localization in video data, including receiving a stream of video data; determining all proposals in the video data stream, the proposals being candidate regions for temporal action in the video data stream; and calculating values for a pair-wise relation function for relating the proposals, wherein the pair-wise relation function calculates a scalar value representing a pair-wise relation weight for pairs of the proposals.

Also described herein is an apparatus including a processor; and a memory accessible by the processor, wherein the memory stores a set of machine-readable instructions permitting the processor to execute this method of temporal action localization in video data.

Also described herein is a module, as implemented in a set of machine-readable instructions for causing a processor to implement this method of temporal action localization in video data.

### BRIEF DESCRIPTION OF THE DRAWINGS

FIG. 1 shows exemplarily the concept of capturing context information in a video;

FIG. 2 shows exemplarily the concept of capturing context information in the present invention by incorporation of a relation attention module 200 of the present invention;

FIG. 3 shows the sequence of temporal action localization processing using the relation attention module;

FIG. 4 shows exemplarily the computation flow in the relation attention module;

FIG. 5 shows an exemplary network for temporal action localization using the relation attention module as embedded in a Structured Segment Network (SSN) architecture;

FIG. 6 depicts a cloud computing environment according to an embodiment of the present invention; and

FIG. 7 depicts abstraction model layers according to an embodiment of the present invention.

### DETAILED DESCRIPTION

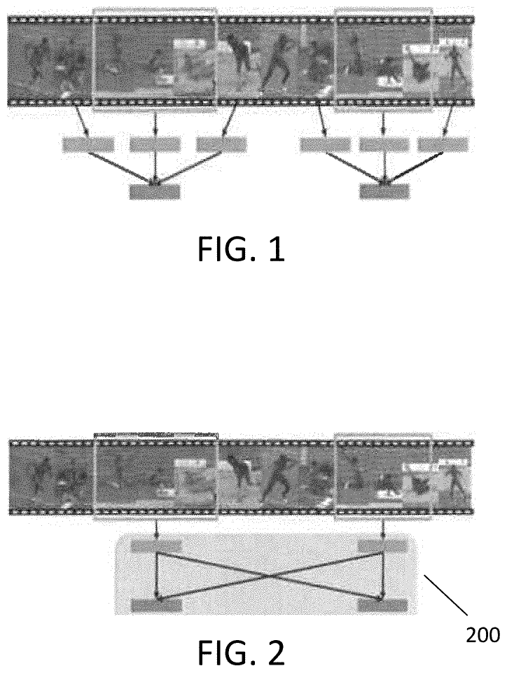

The present inventors have observed that some proposals in video temporal action localization processing could share complementary information regarding to one specific action category. For example, the video exemplarily shown in FIG. 1 of “long jumping” usually consists of both background information (e.g., a sand pool) and actions (e.g., jumping, running). Such information can be complementary and provides clues for temporal reasoning, which helps the understanding of actions. Therefore, in view of this observation, the range of searching for context information for a video temporal action localization proposal should not be restricted locally, since proposals that are distant from the target proposal may also contain helpful information. To make full use of all the proposals in one video, the present invention discloses to exploit the relation between all of the proposals.

Most conventional methods of temporal action localization involve two stages: generating proposals and recognizing them. As mentioned above, the relation between proposals can be critical for recognition. However, most existing methods process proposals individually, which neglects the relation information. The module of the present invention captures relations among proposals, allowing the network to seek information from other proposals automatically and to boost the classification performance. This module, referred to herein as the relation attention module (RAM), is designed with reference to the self-attention mechanism used to solve dependency between words in machine translations.

As exemplarily illustrated in FIG. 2, this relation attention module 200 takes a set of proposal features as input and outputs the enhanced representations with relation information for each proposal. In contrast to FIG. 1, the proposal evaluation technique of the present invention uses proposals that can be either adjacent or distant from each other.

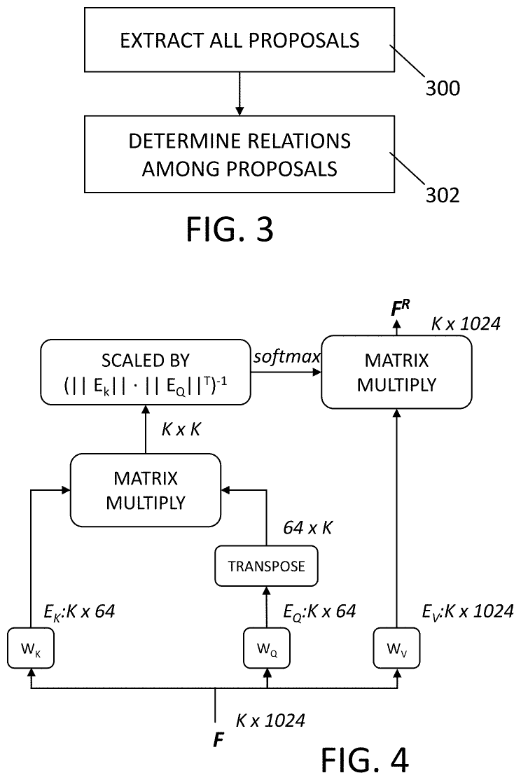

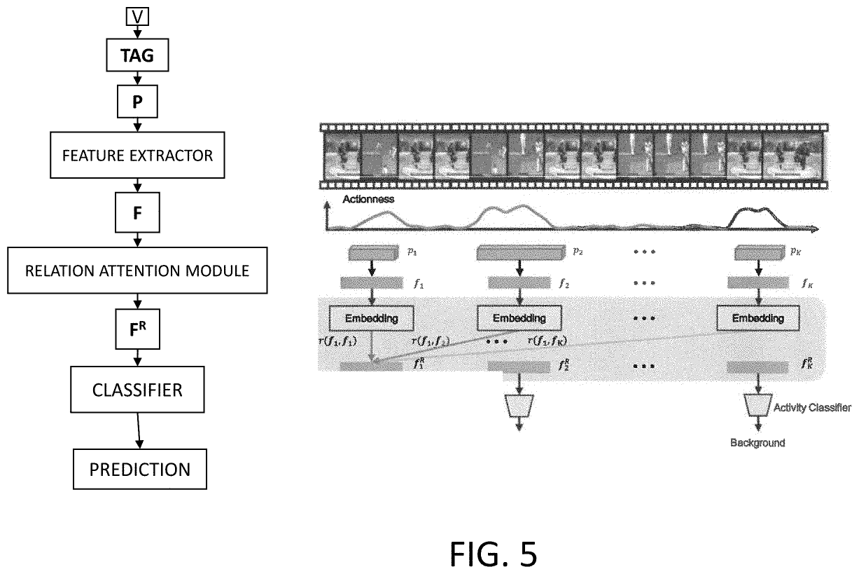

In summary, as shown in FIG. 3, the temporal action localization technique of the present invention first extracts in step 300 the features for all the proposals of a video and then in second step 302 provides the proposals/features as input data into the relation attention module 200 which determines relations among proposals. The output enhanced features can be regarded as the weighted average of all input features based on the learned relationship between proposals. The relation attention module can be used in the two-stage temporal action localization paradigm as embedded in, for example, the Structured Segment Network (SSN), which is a popular method for temporal action recognition, as further explained in reference to FIG. 5.

This relation attention mechanism boosts temporal action localization performance using relation information between portions of a video. The goal is to seek useful information from other portions to build a stronger representation, which is helpful to increase the portion recognition accuracy. A key underlying idea is the design of a pairwise relation function to measure the relation between the two portions of the video. Thus, for a targeted portion, a stronger representation is built using weighted average among all portions, in which the weights are calculated by a pair-wise relation function. The novelty of this approach is that the information from other portions is exploited to assist the recognition of target portion, instead of recognizing it only use its own features.

This technique of evaluating a proposal by relating to other proposals of the video is referred to herein as the “relation attention mechanism”, which in spirit is similar to the self-attention mechanism for language translation. The relation attention module of the present invention is flexible so that it can be embedded in existing networks because of the following properties: 1) No extra supervision is required because it is not necessary to define any constraint for what relations should be learned; 2) The relation attention module is designed in-place to keep the dimension of input and output the same; and 3) The network with relation attention module can be trained in an end-to-end manner.

Although the relation attention module of the present invention shares the similar spirit with recent self-attention method for machine translation, where a specific position of output consists of information from all positions of the input signal, the present invention uses this method for video understanding. Non-local neural network is also related to self-attention and is applicable to other domains in addition to machine translation. However, it models the relationship between pixels of images or videos and thus captures the low-level features. In contrast, the relation attention module of the present invention instead focuses on the relationship between high-level features (i.e., proposal-level), which brings more semantic information. All operations of our module can be implemented by basic operators and the computation flow chart is showed in FIG. 4 for the Sim·Cos similarity pair-wise relation function described below.

The Relation Attention Module

The relation attention module of the present invention effectively exploits the relations between video proposals and can be embedded into current action localization algorithms without many modifications. The efficacy of this technique of adding relation information between proposals was evaluated as yielding significant improvement compared to the baselines on temporal action localization task. In one evaluation using the Structured Segment Networks as a baseline, the relation attention module was demonstrated to improve performance from 29.80 to 31.92. Additionally, stable improvements were witnessed on different types of proposal sets and backbone networks.

To illustrate the relation attention module more formally, let

P={pₖ=(pₖ^{s}, pₖ^{e})}ₖ₌₁^{K}

denote the proposal set of one video, where K is the total number of proposals, Pₖ^{s} and Pₖ^{e} are starting and ending points of the k^{th} proposal respectively. For the k^{th} proposal, the corresponding features fₖ are obtained through a feature extractor, and thus leading to feature set

F={fₖ}ₖ₌₁^{K}.

Given the input feature set F, the output features of the relation attention module with respect to the kth input features are computed as

fₖ^{R}=Σⱼ₌₁^{K}r(fₖ, fⱼ)g(fⱼ). (1)

The function r(·) takes a pair of features as input and outputs a scalar, representing the pairwise relation weight. The function g(·) transforms the input features to the embedding subspace, and j is the index enumerating all input features. The output features for the k^{th} proposal can be viewed as the weighted average of all input proposal features in the sub-space.

Following non-local neural network notation, function g(·) is simply designed as g(fⱼ)=Wv fⱼ, where Wv works as a linear embedding matrix, being implemented as 1×1 convolution. The dimension of the embedding is kept to be the same as the input features. The pairwise relation function r(·) is a key component of the relation attention module and is discussed next.

The Pairwise Relation Function

There are several function that can be used for the relation function r(·). Two non-limiting examples include similarity and relation-FC.

The Similarity Pairwise Relation Function

Inspired by the “scaled dot-product attention” mechanism used by Vaswani et al. for solving dependency between words in a machine translation task, one possibility for the relation function r(·) is similarity between two features followed by a softmax operation to exploit their relationship. Specifically,

r(fₖ, fⱼ)=e^{s(f}^{ₖ}^{,f}^{ⱼ}⁾/Σₜ₌₁^{K}e^{s(f}^{ₖ}^{, f}^{ᵢ}⁾,

where S(·) measures the similarity. Here, we formulate the function S(·) as

S(fₖ, fⱼ)=C·[(W_{Q}fₖ)^{T}(W_{K}fⱼ)],

where C is the scale factor and W_{Q} and W_{K} are two matrices transforming input features into two sub-spaces with dimension d. In this exemplary embodiment, there are multiple possible solutions for selecting C. Non-limiting examples include:

1) When C=[∥W_{Q}fₖ∥·∥W_{Q}fⱼ∥]⁻¹, S is the cosine similarity (Sim-Cos).

2) If C is set to 1, then S is the general dot product of the two embedding feature vectors (Sim-Dot), and equation (1) above becomes the “embedded gaussian” form in non-local neural networks.

3) When C=1/d, the similarity function is the same as the self-attention mechanism used in Vaswani's machine translation mechanism.

The FC Pairwise Relation Function

Another exemplary alternative to similarity, is to use the fc layer (fully-connected layer) to instantiate the function S(·), which exemplary embodiment is referred to as Relation-FC. Specifically, two input features are concatenated in the subspace, followed by a fc with a scalar output. Function S(·) is defined as

S(W_{Q}fₖ, W_{K}fₗ)=ReLU(w_{S}·[W_{Q}fₖ, W_{K}fₖ]),

where [·,·] denotes the concatenation operation. Here, the relationship between input features are modeled by a learnable vector w_{S} with activation function ReLU.

Temporal Action Localization with the Relation Attention Module

Having described above some exemplary embodiments of the relation attention module, FIG. 4 shows how this module can be embedded into SSN to provide good performance. As mentioned, the Structured Segment Network (SSN) is a popular method used for temporal action recognition. FIG. 4 shows only the process of getting the first enhanced features f₁^{R}. The STPP and completeness classifier are not presented, since they are not necessary operations for the common two-stage temporal action localization paradigm.

In the proposals generation stage, SSN generates a proposal set by the temporal actionness grouping (TAG) algorithm, an algorithm which finds continuous temporal regions with high actionness scores to sever as proposals. Several frames are selected uniformly from the proposal to construct activity features. Using several frames also augments the span of proposals and use Structured Temporal Pyramid Pooling (STPP) to build completeness features. In the recognition stage, activity features and completeness features are fed into an activity classifier and completeness classifier separately, which are respectively responsible for determining the category of the proposal and judge whether the proposal contains a complete action instance.

To provide a more general case, this exemplary embodiment embeds the relation attention module before the activity classifier [? to exploit the relations between activity features.?] Specifically, the relation attention module takes the activity proposal feature set F={fₖ}ₖ₌₁^{K} as input and outputs a collection of enhanced features F^{R}={fₖ^{R}}ₖ₌₁^{K}, where K is the number of selected proposals for one video. During training for one exemplary test embodiment in which the limitation of GPU (graphical processor unit) memory was considered, eight proposals were selected for each video, but during testing phase, a variable number of proposals were selected.

It is noted that testing of the relation attention module in a conventional SSN demonstrated improved performance by a large margin and is competitive with other state-of-the-art methods.

The embedding of the relation attention module of the present invention does not change the activity classifier. Rather, such embedding enhances its input features with information from various proposals. Similarly, because of this property, the relation attention module could also be embedded in any two-stage framework with proposals and classifiers.

Although the present invention has been described in various embodiments, it should be noted that other variations are also possible. As unlimiting examples, one embodiment described above used the TAG algorithm to identify proposals. Other algorithms, such as BSN and SW, have been shown to provide results consistent with the embodiment using the TAG algorithm. Additionally, although the SSN backbone network was used in the above explanation, other backbone networks such as the BN-Inception and Inception-3 networks have been used and demonstrate similar improvements when the relation attention module of the present invention is incorporated.

Moreover, because of the underlying mathematical complexity, one having ordinary skill in the art clearly understands that the present invention would inherently require implementation on a computer. However, as also well known in the art, such computer implementation could be done in various methods, including an implementation on a local computer such as a desktop computer having access to a temporal action localization program such as described herein. It could also be implemented on a remote server accessible to a user desiring to have a video stream processed for temporal action localization. And, the computer implementation could also be achieved using a cloud service that makes video analysis available for such purposes as motion analysis of a security video stream.

The present invention can be implemented in a number of various computer implementations, including a cloud service being offered which receives video data and performs the service of temporal action localization. Therefore, it would also to be understood by one of ordinary skill that, although this disclosure includes a detailed description on cloud computing, as follows, implementation of the teachings recited herein are not limited to a cloud computing environment. Rather, embodiments of the present invention are capable of being implemented in conjunction with any other type of computing environment now known or later developed.

It would also to be understood by one of ordinary skill that although this disclosure includes a detailed description on cloud computing, as follows, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

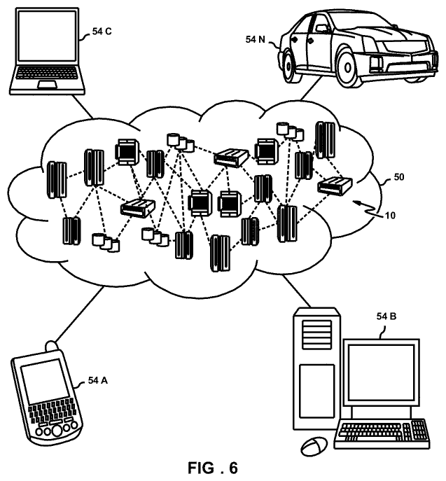

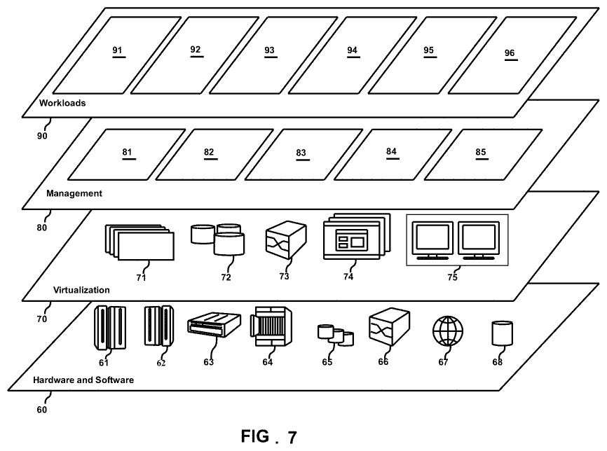

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include tasks related to the implementation of the present invention since the processing of a video signal in accordance with the method described herein could be analyzed as a cloud service.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

What is claimed is:

1. A method of temporal action localization in video data, the method comprising:
receiving a stream of video data;
determining all proposals in the video data stream, the proposals being candidate regions for temporal action in the video data stream; and
calculating values for a pair-wise relation function for relating the proposals,
wherein the pair-wise relation function calculates a scalar value representing a pair-wise relation weight for pairs of the proposals.

2. The method of claim 1, as incorporated into a two-stage temporal action localization processing comprising a first stage of generating proposals which are likely to contain actions and a second stage of performing a classification and a boundary regression on each proposal individually.

3. The method of claim 2, wherein the two-stage temporal action localization processing comprises a Structured Segment Network (SSN).

4. The method of claim 1 wherein the pair-wise relation function comprises a calculation of a similarity between two features of pairs of the proposals followed by a softmax operation.

5. The method of claim 1 wherein the pair-wise relation function comprises a cosine similarity function.

6. The method of claim 1, wherein the pair-wise relation function comprises a dot product of two embedding feature vectors.

7. The method of claim 1, wherein the pair-wise relation function comprises a self-attention mechanism.

8. The method of claim 1, wherein the pair-wise relation function is implemented in an fc layer.

9. The method of claim 1, as implemented in a cloud service.

10. The method of claim 1, as embodied as a set of machine-readable instructions in a non-transitory memory device.

11. A computer product comprising a non-transitory memory device having stored therein a set of machine-readable instructions permitting a processor to execute the method of claim 1.

12. An apparatus, comprising:
a processor; and
a memory accessible by the processor,
wherein the memory stores a set of machine-readable instructions permitting the processor to execute a method of temporal action localization in video data, the method comprising:
receiving a stream of video data;
determining all proposals in the video data stream, the proposals being candidate regions for temporal action in the video data stream; and
calculating values for a pair-wise relation function for relating the proposals,
wherein the pair-wise relation function calculates a scalar value representing a pair-wise relation weight for pairs of the proposals.

13. The apparatus of claim 12, wherein the method is incorporated into a two-stage temporal action localization processing comprising a first stage of generating proposals which are likely to contain actions and a second stage of performing a classification and a boundary regression on each proposal individually.

14. A module, as implemented in a set of machine-readable instructions for causing a processor to implement a method of temporal action localization in video data, the method comprising:
receiving a stream of video data;
determining all proposals in the video data stream, the proposals being candidate regions for temporal action in the video data stream; and
calculating values for a pair-wise relation function for relating the proposals,
wherein the pair-wise relation function calculates a scalar value representing a pair-wise relation weight for pairs of the proposals.

15. The module of claim 14, as incorporated into a into a two-stage temporal action localization processing comprising a first stage of generating proposals which are likely to contain actions and a second stage of performing a classification and a boundary regression on each proposal individually.

16. The module of claim 15, wherein the two-stage temporal action localization processing comprises a Structured Segment Network (SSN).

17. The module of claim 14, as implemented in a cloud service.

18. The module of claim 14, as embodied as a set of machine-readable instructions in a non-transitory memory device.

19. The module of claim 14, wherein the pair-wise relation function comprises a calculation of a similarity between two features of pairs of the proposals followed by a softmax operation.

20. The module of claim 14 wherein the pair-wise relation function comprises an fc layer.
